(19) United States
(12) Patent Application Publication
(10) Pub. No.: US 2013/0311711 A1
(43) Pub. Date: Nov. 21, 2013

(54) NONVOLATILE MEMORY DEVICE AND PROGRAM METHOD THEREOF

(71) Applicant: SAMSUNG ELECTRONICS CO., LTD., Gyeonggi-do (KR)

(72) Inventors: Woo-Young Yang, Gyeonggi-do (KR); Han Deok Lee, Gyeonggi-do (KR)

(73) Assignee: SAMSUNG ELECTRONICS CO., LTD., Gyeonggi-do (KR)

(21) Appl. No.: 13/830,785

(22) Filed: Mar. 14, 2013

(30) Foreign Application Priority Data
May 17, 2012 (KR) 10-2012-0052591

(51) Int. Cl. G06F 12/02

(52) U.S. Cl. CPC G06F 12/0246
USPC 711/103

(57) ABSTRACT

Disclosed is a nonvolatile memory device which includes a nonvolatile memory having multi-level cell (MLC) storage; and a controller configured to control the nonvolatile memory, wherein if a logical address of write-requested data coincides with a logical address of data stored in the nonvolatile memory, the controller controls the nonvolatile memory to program the write-requested data prior to programming of a page sharing the same word line as a page including the data stored in the nonvolatile memory.

### CROSS-REFERENCE TO RELATED APPLICATIONS

A claim for priority under 35 U.S.C. §119 is made to Korean Patent Application No. 10-2012-0052591 filed May 17, 2012, in the Korean Intellectual Property Office, the entire contents of which are hereby incorporated by reference.

### TECHNICAL FIELD

The inventive concept described herein relates to a nonvolatile memory device, and more particularly to a nonvolatile memory device capable of supporting a multi-level cells and a multi-level programming method thereof.

### DISCUSSION OF THE RELATED ART

In general, semiconductor memory devices may include volatile memories such as DRAM, SRAM, and the like and nonvolatile memories such as EEPROM, FRAM, PRAM, MRAM, Flash Memory, and the like. While the volatile memories lose their stored contents at power-off, the nonvolatile memories retain the stored contents even at power-off.

In recent years, devices using nonvolatile memory have increased with the increasing consumer use of portable computing and communications devices and solid state disks (SSD). For example, a nonvolatile memory may be used as storage devices of an MP3 player, a digital camera, a portable telephone, a camcorder, a flash card, a solid state disk (SSD), and the like.

As devices using nonvolatile memories as their storage increase in popularity, the demand for greater storage capacities may increase. One of methods of increasing a nonvolatile memory's storage capacity may be to operate in a multi-level cell (MLC) manner in which a plurality of bits is stored in each memory cell.

However, an MLC program method may cause such an error that lower-bit (LSB) data written at one memory cell is damaged by the writing of upper-bit (MSB) data into the other memory cells. For example, in a case where sudden power-off (SPO) or program fail arises during programming of upper-bit (MSB) data, the value of lower-bit (LSB) data stored at a memory cell may be changed by influence of upper-bit (MSB) data being written at the other nearby memory cells.

### SUMMARY

One aspect of the inventive concept is directed to provide a nonvolatile memory device which comprises a nonvolatile memory; and a controller configured to control the nonvolatile memory, wherein if the logical address of write-requested data coincides with the logical address of data already stored in the nonvolatile memory, the controller controls the nonvolatile memory to program the write-requested data (elsewhere) prior to programming of a page sharing the same word line as the page including the data already stored in the nonvolatile memory.

In exemplary embodiments, if the logical address of the write-requested data coincides with the logical address of the data already stored at the nonvolatile memory and the page including the data already stored at the nonvolatile memory is an LSB page, the controller invalidates the data stored in the nonvolatile memory prior to programming of an MSB page sharing the same word line as the LSB page including the data already stored at the nonvolatile memory.

In exemplary embodiments, the controller comprises a mapping checker configured to compare the logical address of the write-requested data with the logical address of the data already stored in the nonvolatile memory; and a backup manager configured to determine a (e.g., same or different/other) location, at which the write-requested data is to be programmed at the nonvolatile memory, based on the comparison result.

In exemplary embodiments, the controller further comprises a mapping table configured to manage the logical address of the data stored in the nonvolatile memory, the physical address of the data stored in the nonvolatile memory, and information indicating whether a page including the data stored in the nonvolatile memory is an LSB page.

In exemplary embodiments, the mapping checker compares the logical address of the write-requested data with a logical address managed at the mapping table; and where if the logical address of the write-requested data coincides with a logical address managed at the mapping table, the mapping checker judges whether a page including data, corresponding to the logical address, from among data stored in the nonvolatile memory is an LSB page.

In exemplary embodiments, when the logical address of the write-requested data coincides with the logical address corresponding to the logical address managed at the mapping table of a page including data already stored in the nonvolatile memory and the page including data already stored is an LSB page, the backup manager performs a program operation on the write-requested data (elsewhere) prior to performing an MSB program operation on an MSB page sharing the same word line as the LSB page.

In exemplary embodiments, when the logical address of the write-requested data coincides with the logical address managed at the mapping table and the page including data, corresponding to the logical address, already stored in the nonvolatile memory is an MSB page, the backup manager performs a program operation on the write-requested data according to the sequence write-requested by a host.

In exemplary embodiments, when the logical address of the write-requested data does not coincide with the logical address managed at the mapping table, the backup manager performs a program operation on the write-requested data according to a sequence write-requested by a host.

In exemplary embodiments, the controller controls the nonvolatile memory to perform a program operation by a unit of plural pages.

In exemplary embodiments, the nonvolatile memory comprises a first word line; a second word line adjacent to the first word line; and a third word line adjacent to the second word line, the controller controlling the nonvolatile memory to perform an LSB program operation on the third word line after performing an MSB program operation on the first word line.

In exemplary embodiments, the nonvolatile memory further comprises a fourth word line adjacent to the third word line. When a logical address of the write-requested data coincides with a logical address of data stored at an LSB page of the third word line, the controller controls the nonvolatile memory to perform a program operation on an MSB page of the third word line after the write-requested data is programmed at an LSB page of the fourth word line.

In exemplary embodiments, the nonvolatile memory comprises a first word line; and a second word line adjacent to the first word line. The controller controls the nonvolatile memory such that an LSB program operation on the first word line, an MSB program operation on the first word line, an LSB program operation on the second word line, and an MSB program operation on the second word line are sequentially performed.

An aspect of the inventive concept is directed to provide a program method of a nonvolatile memory device supporting a multi-level cell manner. The program method comprises receiving write-requested data sequentially; comparing a logical address of the write-requested data with a logical address managed at a mapping table; and when the logical address of the write-requested data coincides with the logical address managed at the mapping table, programming the write-requested data prior to programming of a page sharing the same word lines as a physical page to which the logical address belongs.

In exemplary embodiments, the program method further comprises checking whether a physical page corresponding to the logical address managed at the mapping table is an LSB page, when the logical address of the write-requested data coincides with the logical address managed at the mapping table.

In exemplary embodiments, the program method further comprises performing a program operation according to a sequence write-requested by a host when the logical address of the write-requested data does not coincide with the logical address managed at the mapping table.

Thus, in an exemplary embodiment, a nonvolatile memory device comprises: a nonvolatile memory supporting multi-level cell data storage and includes a plurality (first, second, third) of adjacent word lines and a controller that includes: a mapping checker configured to compare the logical address of write-requested data with the logical address of data already stored in the nonvolatile memory; and a backup manager configured to determine which wordline (e.g., among the first, second, and third wordlines), at which the write-requested data is to be programmed in the nonvolatile memory, based on the comparison result.

The controller may be configured to perform a program operation on the write-requested data according to a sequence write-requested by a host if a first condition or a second condition is detected. The nonvolatile memory device may further comprise: a mapping table configured to manage a logical address of the data stored in the nonvolatile memory, a physical address of the data stored in the nonvolatile memory, and information indicating whether a page including the data already stored in the nonvolatile memory is an LSB page, and the first condition is that the logical address of the write-requested data coincides with a logical address managed at the mapping table and the page including data, corresponding to the logical address, from among data already stored in the nonvolatile memory is an MSB page, and the second condition is that the logical address of the write-requested data does not coincide with a logical address managed at the mapping table.

The controller may be further configured to perform a program operation on the write-requested data according to a sequence different from the sequence write-requested by a host if a third condition is detected, wherein the third condition may be that the logical address of write-requested data coincides with the logical address of data already stored in the nonvolatile memory, and the page corresponding to the logical address of data already stored in the nonvolatile memory is an LSB page.

Embodiments will be described in detail with reference to the accompanying drawings. The inventive concept, however, may be embodied in various different forms, and should not be construed as being limited only to the illustrated embodiments. Rather, these embodiments are provided as examples so that this disclosure will be thorough and complete, and will fully convey the concept of the inventive concept to those skilled in the art. Accordingly, known processes, elements, and techniques are not described with respect to some of the embodiments of the inventive concept. Unless otherwise noted, like reference numerals denote like elements throughout the attached drawings and written description, and thus descriptions will not be repeated. In the drawings, the sizes and relative sizes of layers and regions may be exaggerated for clarity.

It will be understood that, although the terms “first”, “second”, “third”, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the inventive concept.

The terminology used herein is for the purpose of describing particular embodiments only and is not intended to be limiting of the inventive concept. As used herein, the singular forms “a”, “an” and “the” are intended to include the plural forms as well, unless the context clearly indicates otherwise. As used herein, the term “and/or” includes any and all combinations of one or more of the associated listed items. Also, the term “exemplary” is intended to refer to an example or illustration.

It will be understood that when an element or layer is referred to as being “on”, “connected to”, “coupled to”, or “adjacent to” another element or layer, it can be directly on, connected, coupled, or adjacent to the other element or layer, or intervening elements or layers may be present. In contrast, when an element is referred to as being “directly on,” “directly connected to”, “directly coupled to”, or “immediately adjacent to” another element or layer, there are no intervening elements or layers present. A first wordline said to be “adjacent” to a second wordline if no other wordline intervenes between the first and second wordlines.

Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and/or the present specification and will not be interpreted in an idealized or overly formal sense unless expressly so defined herein.

### BRIEF DESCRIPTION OF THE FIGURES

The above and other features will become apparent from the following description with reference to the following figures, wherein like reference numerals refer to like parts throughout the various figures unless otherwise specified, and wherein:

FIG. 1 is a block diagram of a memory system according to an exemplary embodiment of the inventive concept;

FIG. 2 is a block diagram of a flash memory system according to an exemplary embodiment of the inventive concept;

FIGS. 3 and 4 are circuit diagrams illustrating a memory block comprising NAND strings and pages in the flash memory 1210 in the flash memory system of FIG. 2;

FIG. 5 shows threshold voltage distribution diagrams illustrating an example that data stored at an LSB page is damaged at sudden power-off;

FIGS. 6 and 7 are diagrams illustrating a conventional manner where write-requested data is programmed at a flash memory according to a sequence write-requested from a host;

FIGS. 8 and 9 are diagrams illustrating a program operation of a flash storage device according to an exemplary embodiment of the inventive concept;

FIGS. 10 to 12 are diagrams illustrating a flash storage device according to an exemplary embodiment of the inventive concept;

FIGS. 13 to 15 are diagrams illustrating a flash storage device according to an exemplary embodiment of the inventive concept;

FIG. 16 is a flow chart illustrating the method of a program operation of a flash storage device according to an exemplary embodiment of the inventive concept;

FIG. 17 is a block diagram of a memory card system incorporating a flash memory system according to an exemplary embodiment of the inventive concept is applied;

FIG. 18 is a block diagram illustrating a solid state drive system incorporating a memory system according to the inventive concept is applied;

FIG. 19 is a block diagram of the SSD controller in the solid state drive system of FIG. 18;

FIG. 20 is a block diagram of an electronic device including a flash memory system according to an exemplary embodiment of the inventive concept;

FIG. 21 is a block diagram of a flash memory applied to the inventive concept;

FIG. 22 is a perspective view schematically illustrating the 3D structure of a memory block illustrated in FIG. 21; and

FIG. 23 is a circuit diagram of an equivalent circuit of the memory block illustrated in FIG. 22.

### DETAILED DESCRIPTION OF EXEMPLARY EMBODIMENTS

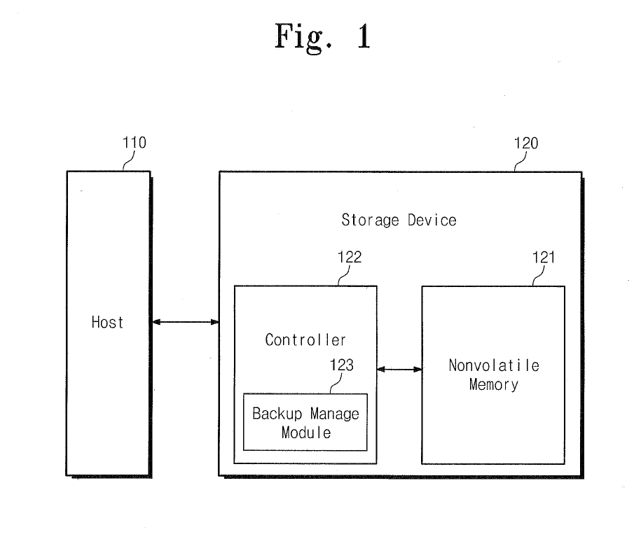

FIG. 1 is a block diagram of a memory system according to an exemplary embodiment of the inventive concept. In FIG. 1, the memory system 100 supports performing a programming method including a step of adjusting the program sequence of write-requested data. Referring to FIG. 1, the memory system 100 includes a host 110 and a storage device 120. The storage device 120 includes a nonvolatile memory 121 and a controller 122.

The storage device 120 stores data from the host 110 at the nonvolatile memory 121 in response to a write request of the host 110. The storage device 120 sends data stored in the nonvolatile memory 121 to the host 110 in response to a read request of the host 110. The nonvolatile memory 121 may be implemented by NAND flash memory, PRAM, ReRAM, FRAM, PRAM, NOR flash memory, and the like.

The controller 122 may control the overall operation of the storage device 120. For example, when a write request is received from the host 110, the controller 122 may receive write-requested data from the host 110, and controls the nonvolatile memory 121 such that the write-requested data is to be programmed at the nonvolatile memory 121. When a read request is received from the host 110, the controller 122 may read read-requested data from the nonvolatile memory 121 to transfer it to the host 110. The controller 122 includes a backup manage module 123.

When a write request is received from the host 110, the backup manage module 123 judges whether a logical address of write-requested data coincides with a logical address corresponding to any data of data already stored at the nonvolatile memory 121. If a logical address of write-requested data coincides with a logical address corresponding to any already stored data, the backup manage module 123 may adjust the program sequence of the write-requested data (or, a program location of the write-requested data) to minimize an LSB backup operation.

In a multi-level cell (MLC) manner where two or more bits of data are stored in each memory cell, sudden power-off can occur while programming MSB data. In this case, LSB data stored at a corresponding memory cell can be damaged. To prevent this danger, in general, a predetermined area of the nonvolatile memory 121 may be assigned to serve as an LSB data backup area. This practice may necessitate a large space for backing up LSB data. Thus, a user data area of the nonvolatile memory 121 may be reduced.

To solve the problem, the memory system 100 according to an exemplary embodiment of the inventive concept provides the backup manage module 123. The backup manage module 123 minimizes an LSB backup operation by adjusting the program sequence of write-requested data (or, a program location of the write-requested data). Thus, the backup manage module 123 can minimize the LSB backup operation by invalidating LSB data of a corresponding memory cell before an MSB program operation is executed. Thus, the amount of storage space set aside for LSB backup may be reduced.

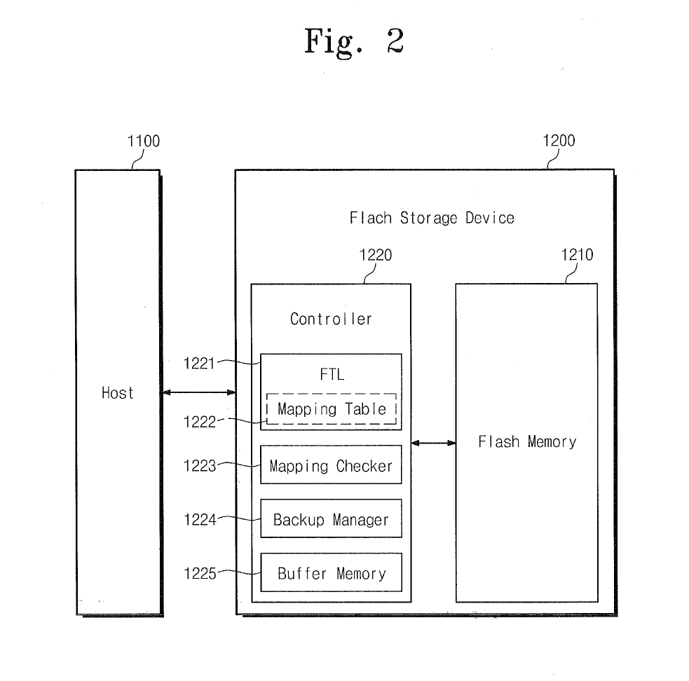

FIG. 2 is a block diagram of a flash memory system according to an exemplary embodiment of the inventive concept. Referring to FIG. 2, the flash memory system 1000 may include a host 1100 and a flash storage device 1200. In FIG. 2, a flash memory system according to an exemplary embodiment of the inventive concept can be configured to minimize the number of LSB backup operations. The flash memory 1210 is an example of a nonvolatile memory 121 in FIG. 1. A mapping checker 1223 and a backup manager 1224 in the flash memory system of FIG. 2 may constitute a backup manage module 123 in FIG. 1. The flash storage device 1200 may include a flash memory 1210 and a controller 1220.

The flash memory 1210 may perform an erase operation, a read operation, or a write operation according to the control of the controller 1220. The flash memory 1210 may be formed of a plurality of planes, each of which is formed of a plurality of pages.

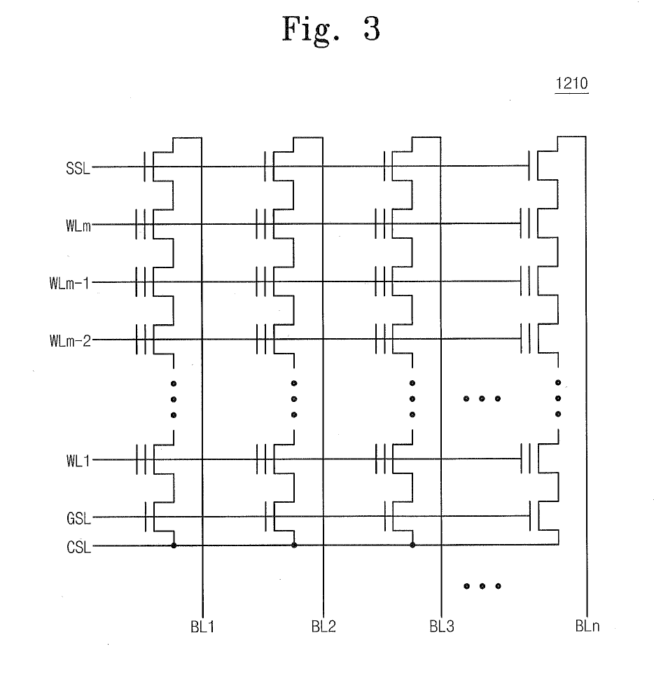

In the flash memory 1210, each memory cell can store one bit of data or two or more bits of data. A memory cell storing one bit of data may be referred to as a single level cell (SCL) or a single bit cell. A memory cell storing two or more bits of data may be referred to as a multi-level cell (MLC) or a multi bit cell. A structure of the flash memory 1210 will be more fully described with reference to FIG. 3.

The controller 1220 controls the overall operation of the flash memory device 1200. The controller 1200 includes a flash translation layer (FTL) 1221, a mapping table 1222, a mapping checker 1223, a backup manager 1224, and a buffer memory 1225.

The flash translation layer 1221 converts a logical address provided from the host 1100 into a physical address of the flash memory 1210. Hereinafter, it is assumed that the flash translation layer 1221 manages data by the page. Thus, the flash translation layer 1221 receives a logical page number LPN from the host 1100 and converts it into a physical page number PPN of the flash memory 1210.

The mapping table 1222 manages information between logical and physical page numbers associated with data stored in the flash memory 1210. For example, when a write request is received from the host 1100, the flash translation layer 1221 convert a logical page number LPN of write-requested data into a physical page number PPN, and stores mapping information between the logical page number LPN and the physical page number PPN at the mapping table 1222.

The mapping table 1222 can manage information associated with whether a page corresponding to a physical page address PPN is an LSB page or an MSB page. The mapping table 1222 may be stored at the buffer memory 1225 or the flash memory 1210, for example.

The mapping checker 1223 checks whether the logical page number LPN of write-requested data provided from the host 1110 coincides with a logical page number LPN managed at the mapping table 1222. Thus, when write-requested data is received from the host 11000, the mapping checker 1223 checks whether a logical page number LPN of the write-requested data coincides with one of logical page numbers managed at the mapping table 1222.

If a logical page number LPN of the write-requested data coincides with one of logical page numbers managed at the mapping table 1222, that may mean that the write-requested data is update data of data (hereinafter, referred to as old data) stored at the flash memory 1210. In a case where the logical page number LPN of the write-requested data coincides with one of logical page numbers managed at the mapping table 1222, further, the mapping checker 1223 checks whether old data stored at the flash memory 1210 is an LSB page or an MSB page.

The backup manager 1224 receives information, associated with whether a logical page number LPN of the write-requested data coincides with one of logical page numbers managed at the mapping table 1222, and information associated with whether old data is an LSB page.

If the logical page number LPN of the write-requested data coincides with one of logical page numbers managed at the mapping table 1222 and if the page associated with old data is an LSB page, the backup manager 1224 adjusts the program sequence (or, the program location) such that the write-requested data is programmed before an MSB page (hereinafter, referred to as a paired MSB page) paired with an LSB page storing old page is programmed.

The buffer memory 1225 temporarily stores data read out from the flash memory 1210 or provided from the host 1100. The buffer memory 1225 may be used to drive firmware such as a flash translation layer (FTL). The buffer memory 1220 may be formed of DRAM, SRAM, MRAM, PRAM, and/or the like.

As described above, if write-requested data is update data of old data and a page storing the old data is an LSB page, the flash storage device 1200 programs the write-requested data prior to programming of an MSB page paired with the LSB page storing the old data.

Thus, the flash storage device 1200 may invalidate the LSB page storing the old data before a paired MSB page is programmed. This may mean that a backup operation for the LSB page storing the old data is not required. Thus, it is possible to minimize an LSB backup operation.

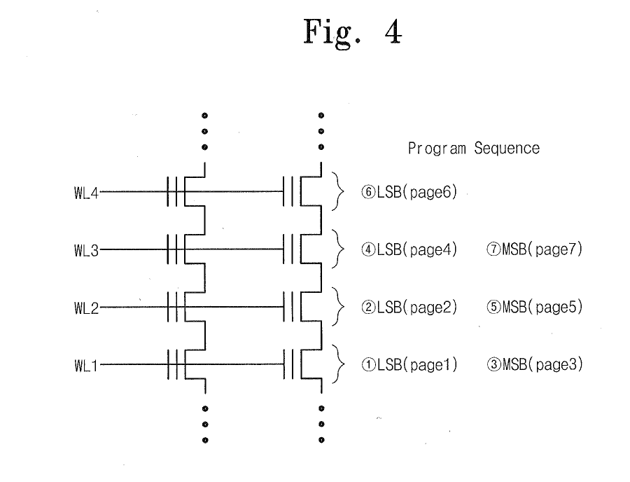

FIGS. 3 and 4 are circuit diagrams illustrating a memory block comprising NAND strings and pages in the flash memory 1210 in the flash memory system of FIG. 2.

Referring to FIG. 3, a flash memory 1210 includes a plurality of memory cells arrayed in a plurality of NAND strings, string selection transistors, and ground selection transistors. Memory cells in different NAND strings may be connected via a word line to constitute one or more pages. Memory cells connected with the same word line may form one or more pages.

For example, in a single-level cell (SLC) manner where one bit is stored at a memory cell, the set of memory cells in different NAND strings connected with one word line may form one page. In a multi-level cell (MLC) manner where two or more bits are stored at each memory cell, a set of memory cells in different NAND strings connected with one word line may form a plurality of pages.

The gate of the string selection transistor may be connected with a string selection line SSL. The drain of each string selection transistor is connected with a corresponding bit line BLi (i being one of 1 to n). The gate of the ground selection transistor is connected with a ground selection line GSL. The drain of the ground selection transistor is connected with a common source line CSL.

In FIG. 4, a program sequence of the flash memory 1210 is illustrated. Hereinafter, it is assumed that a program operation is performed according to a 2-bit MLC manner by which each memory cell stores 2-bit data.

In the 2-bit MLC manner, memory cells sharing the same word line may form two pages. Thus, as illustrated in FIG. 4, memory cells sharing the same word line may form an LSB page and an MSB page.

The flash memory 1210 may perform a program operation according to the sequence illustrated in FIG. 4 to minimize influence of the program disturbance generated at a program operation. Thus, a program operation may be performed in an order of a \textcircled{1}, \textcircled{2}, \textcircled{3}, \textcircled{4}, etc. In FIG. 4, “LSB” indicates an LSB program operation, and “MSB” indicates an MSB program operation.

In accordance with the program sequence in FIG. 4, an MSB program operation is carried out after an LSB program operation on an adjacent word line has been performed. Thus, it is possible to minimize influence of the program disturbance.

In case of the above-described program sequence, a first word line WL1 corresponds to a first page being an LSB page and a third page being an MSB page. In this case, as described above, the first page and the third page are paired. Likewise, a second page and a fifth page share a second word line WL2, and are paired. A fourth page and a seventh page share a third word line WL3, and are paired.

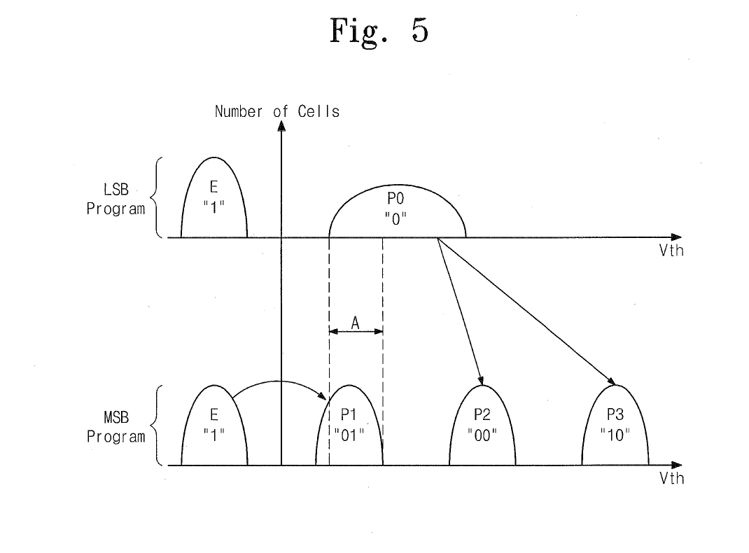

FIG. 5 shows threshold voltage distribution diagrams illustrating an example that data stored at an LSB page is damaged at sudden power-off. In FIG. 5, there is illustrated a threshold voltage distribution occurring when an LSB program operation is executed and a threshold voltage distribution occurring when an MSB program operation is afterwards performed.

While no program operation has been performed since an erase operation, memory cells have an erase state E. If an LSB program operation is performed, memory cells having the erase state E may maintain the erase state E or be programmed to an initial program state P0. In this case, memory cells having the erase state E have LSB data of ‘1’, and memory cells having the initial program state P0 have LSB data of ‘0’.

If an MSB program operation is performed, memory cells having an erase state E may maintain the erase state E or be programmed to a first program state P1. Also, memory cells having the initial program state P0 may be programmed to a second program state P2 or to a third program state P3.

The first, second, and third program states P1, P2, and P3 have data of ‘01’, data of ‘00’, and data of ‘10’, respectively. In data of ‘LR’, the right data bit ‘R’ indicates an LSB data bit, and the left data bit ‘L’ indicates an MSB data bit. For example, memory cells having the first program state P1 may store data of ‘01’, in which a right data bit ‘1’ indicates an LSB data bit and a left data bit ‘0’ indicates an MSB data bit.

If sudden power-off occurs during an MSB program operation, LSB data of memory cells, belonging to a region ‘A’, from among memory cells programmed to the first program state P1 may be damaged. The reason may be that LSB data of memory cells belonging to the region ‘A’ is changed from ‘0’ to ‘1’ due to the MSB program operation. To prevent this, a predetermined area of the nonvolatile memory 121 may be assigned to an LSB data backup area. However, in case that an LSB backup operation is performed with respect to all LSB data, the available user data area of the flash memory 1210 may be reduced.

A flash storage device 1200 according to an exemplary embodiment of the inventive concept programs write-requested data prior to programming of a paired MSB page of an LSB page storing old data. Thus, the flash storage device 1200 may invalidate the LSB page storing the old data before a paired MSB page is programmed. Thus, it is possible to minimize an LSB backup operation.

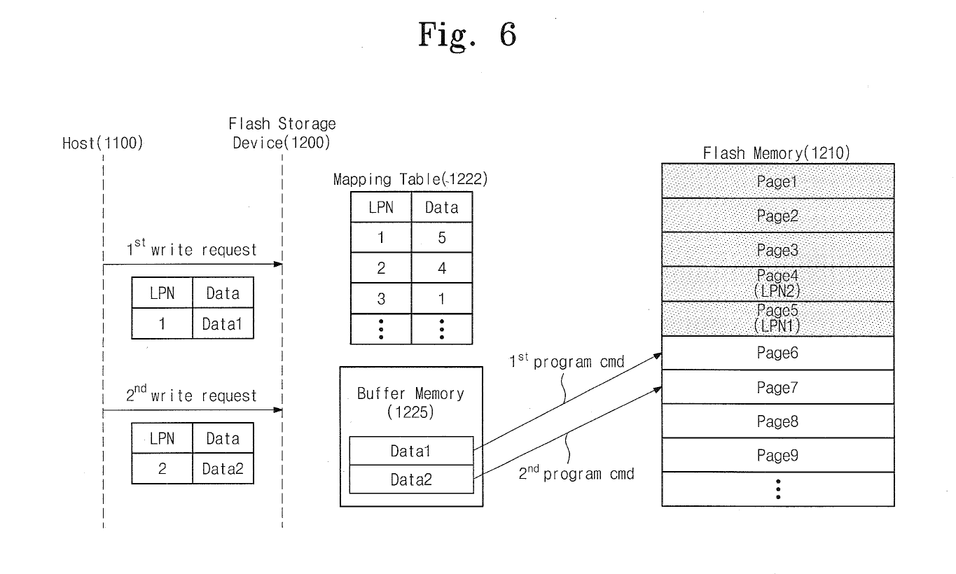

Below, a program operation of a flash storage device according to an exemplary embodiment of the inventive concept will be more fully described with reference to FIGS. 6 to 9.

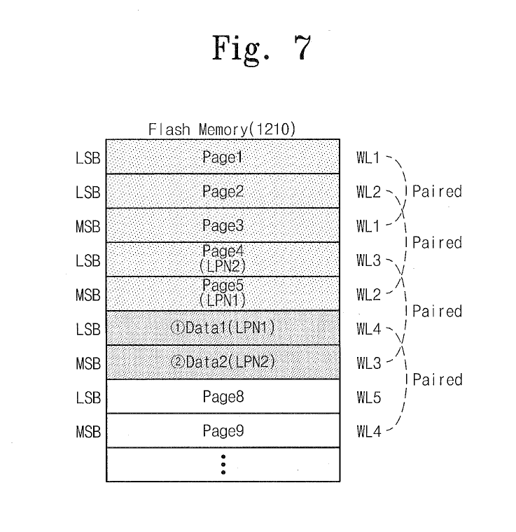

FIGS. 6 and 7 are diagrams illustrating a conventional manner where write-requested data is programmed at a flash memory according to a sequence write-requested from a host.

For ease of description, it is assumed that logical page numbers of write-requested data coincide with logical page numbers managed at a mapping table 1222. Also, it is assumed that a program operation of a flash memory 1210 is performed in a manner described with reference to FIG. 4. Also, it are assumed here that data was programmed at first to fifth pages (page1 to page5) of the flash memory 1210 and that logical page numbers (LPN) corresponding to data stored at fourth and fifth pages (page4 and page5) are ‘LPN2’ and ‘LPN1’, respectively.

Referring to FIG. 6, a flash storage device 1200 sequentially receives a first write request and a second write request from a host 1100. It is assumed that the logical page number (LPN) of first data Data1 write-requested at the first write request is ‘LPN1’. It is assumed that the logical page number of second data Data2 write-requested at the second write request is ‘LPN2’. The first data Data1 and the second data Data2 may be sequentially stored at a buffer memory 1225.

Afterwards, a program operation for writing the first and second data Data1 and Data2 into the flash memory 1210 may be executed. In a conventional case, as illustrated in FIG. 6, the first data Data1 and the second data Data2 may be sequentially programmed to a sixth page and a seventh page, respectively.

In this case, Referring to FIG. 7, the fourth page and the seventh page are paired, and LSB data may be stored at the fourth page. In a case where the second data Data2 is programmed to the seventh page, data stored at the fourth page may be still valid.

Thus, in FIGS. 6 and 7, if the first and second data Data1 and Data2 are programmed according to a sequence write-requested from the host 1100, a backup operation on LSB data stored at the fourth page must be performed. This may mean that available user data area of the flash memory 1210 is reduced.

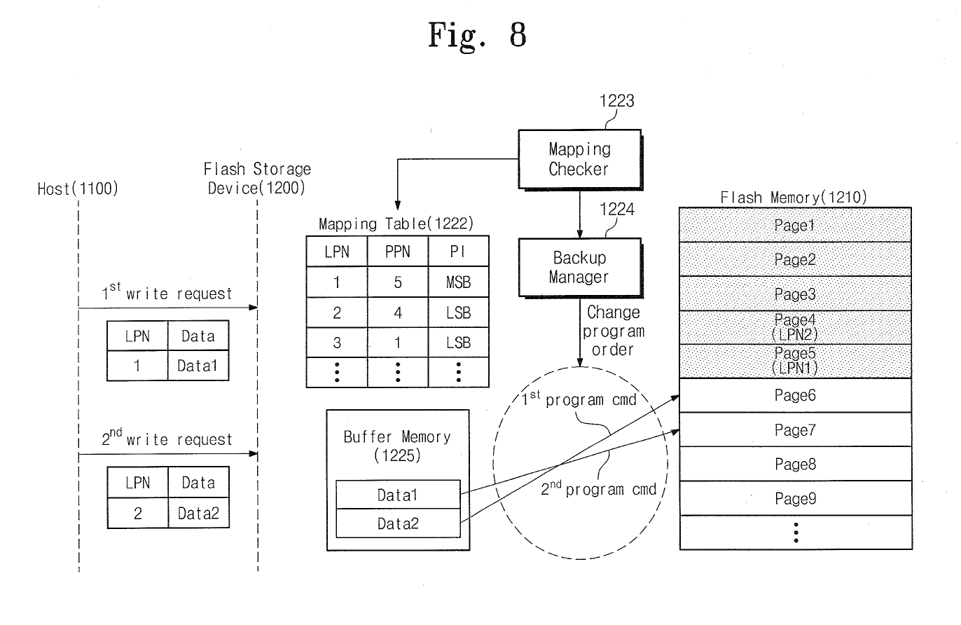

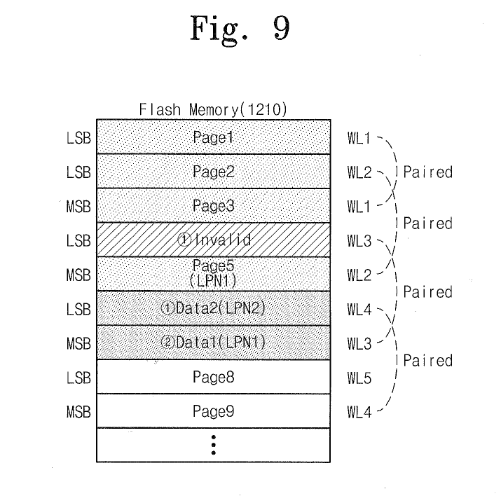

FIGS. 8 and 9 are diagrams illustrating a program operation of a flash storage device according to an exemplary embodiment of the inventive concept.

For ease of description, it is assumed that write requests of a host 1100 and data already stored in a flash memory 1210 are the same as described in FIGS. 6 and 7. Also, it is assumed that the flash memory 1210 performs a program operation in such a manner as illustrated in FIG. 4.

Referring to FIG. 8, a flash storage device 1200 sequentially receives a first write request and a second write request from the host 1100. A first data Data1 and a second data Data2 may have logical page numbers of ‘LPN1’ and ‘LPN2’, respectively. The first data Data1 and the second data Data2 are sequentially stored in a buffer memory 1225.

A mapping checker 1223 judges whether logical page numbers of the write-requested data Data1 and Data2 coincide with logical page numbers managed in the mapping table 1222.

In FIG. 8, the logical page numbers (LPN1 and LPN2) of the first and second data Data1 and Data2 are managed at the mapping table 1222. This may mean that the first data Data1 is update data about data stored at a physical page number PPN of ‘5’. In this case, data stored at the physical page number PPN of ‘5’ may be referred to as old data of the first data Data1. Likewise, the second data Data2 may be update data about data stored at a physical page number PPN of ‘4’. In this case, data stored at the physical page number PPN of ‘4’ may be referred to as old data of the second data Data2.

In the event that logical page numbers of ‘LPN1’ and ‘LPN2’ are managed at the mapping table 1222, the mapping checker 1223 judges whether old data corresponding to the logical page numbers of ‘LPN1’ and ‘LPN2’ is data stored at an LSB page or data stored at an MSB page.

As illustrated in FIG. 8, information indicating whether a page storing data is an LSB page or an MSB page may be managed by the mapping table 1222. The information indicating whether a page storing data is an LSB page or an MSB page may be referred to as program information PI.

A backup manager 1224 may receive information indicating that the first and second data Data1 and Data2 is update data associated with data stored at the flash memory 1210. Also, the backup manager 1224 may receive information indicating that a page storing old data of the second data Data2 is an LSB page, from the mapping checker 1223.

In this case, the backup manager 1224 may skip an LSB backup operation on data stored at a fourth page by changing the program sequence of the first and second data Data1 and Data2. Thus, the backup manager 1224 may skip an LSB backup operation by invalidating LSB data of a fourth page before a seventh page paired with the fourth page is programmed.

In detail, data corresponding to a logical page number of ‘2’ (LPN2) was stored at the fourth page. Thus, data stored at the fourth page may be old data of the second data Data2.

Referring to FIG. 9, the second data Data2 may be programmed at a sixth page. In this case, since data stored at the fourth page is old data of the second data Data2, LSB data stored at the fourth page may be invalidated.

Afterwards, the first data Data1 may be programmed at the seventh page. In this case, although the seventh page and the fourth page are paired, data stored at the fourth page may be invalidated data. Thus, unlike FIGS. 6 and 7, the flash storage device 1200 according to an exemplary embodiment of the inventive concept need not perform a backup operation on LSB data stored at the fourth page.

As a result, the flash storage device 1200 according to an exemplary embodiment of the inventive concept can minimize an LSB backup operation by invalidating data stored at an LSB page before an MSB page paired with the LSB page (sharing same wordline) is programmed.

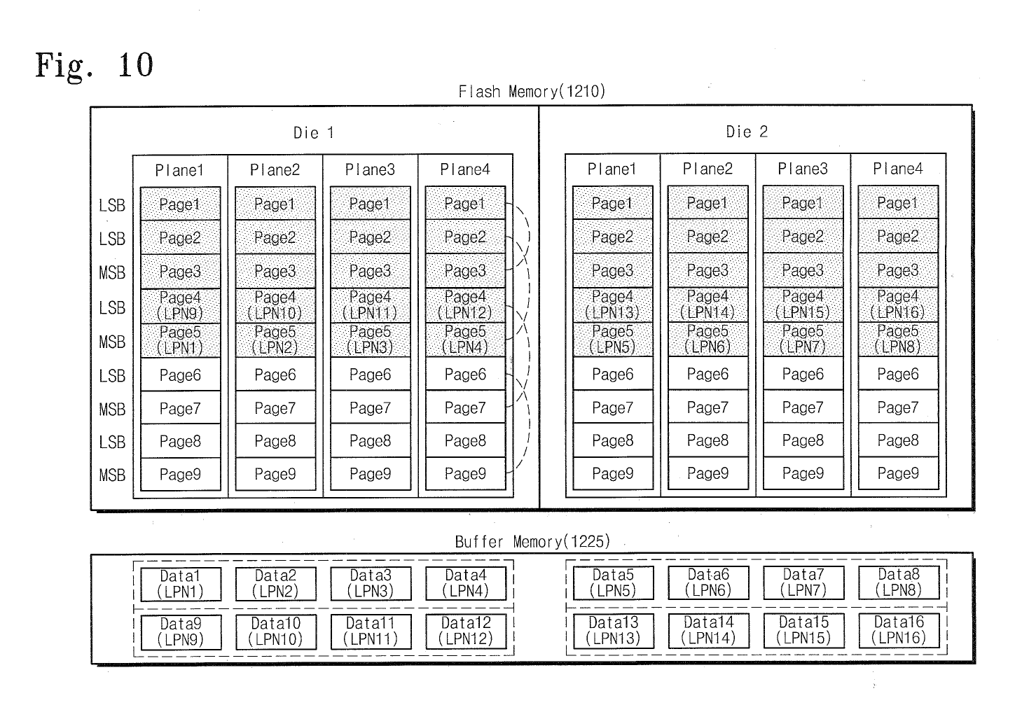

FIGS. 10 to 12 are diagrams illustrating a flash storage device according to an exemplary embodiment of the inventive concept. In FIGS. 10 to 12, a flash storage device performs a program operation by a unit of a plurality of planes if each wordline spans multiple planes.

A flash storage device to be described with reference to FIGS. 10 to 12 is similar to that in FIG. 2. In FIGS. 10 to 12, constituent elements that are similar to those in FIG. 2 are marked by similar reference numerals. A flash storage device described with reference to FIGS. 2 to 9 has a program unit formed of one plane, and a flash storage device to be described with reference to FIGS. 10 to 12 has a program unit formed of four planes.

Referring to FIG. 10, a flash memory 1210 includes a first die and a second die, each of which includes first to fourth planes Plane1 to Plane4. Herein, the first and second dies may be connected with a controller 1220 via the same channel, and may be formed of separate chips. Each plane may include a plurality of wordlines and of pages.

It is assumed here in this illustration that 1^{st} to 15^{th} data Data1 to Data15 stored at a buffer memory 1225 is to be sequentially write-requested from a host 1100 (refer to FIG. 2). Also, as illustrated in FIG. 10, it is assumed that data was already stored at 1^{st} to 5^{th} pages (page1 to pages) of the first and second dies.

“LPN 0” of a fourth page of the first plane in the first die indicates that a logical page number LPN of data stored at a corresponding page is ‘0’. Likewise, “LPN 1” of first data Data1 stored at the buffer memory 1225 indicates that a logical page number LPN of the first data Data1 write-requested is ‘1’.

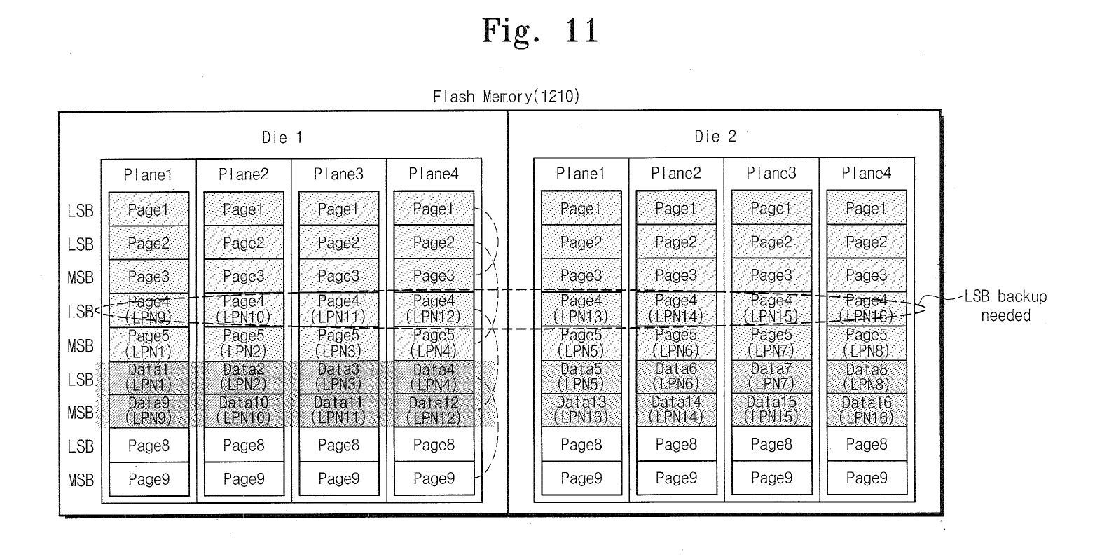

Referring to FIG. 11, there is illustrated an example that 1^{st} to 15^{th} data Data1 to Data15 are to be sequentially programmed at the flash memory 1210 according to a sequence write-requested from the host 1100.

As illustrated in FIG. 11, in the case that 1^{st} to 15^{th} data Data1 to Data15 are sequentially programmed at the flash memory 1210, an LSB backup operation must be performed (only) with respect to fourth pages of the first and second dies.

Thus, when seventh (MSB) pages are programmed, LSB data stored at the fourth pages paired with the seventh pages may be valid data. In this case, LSB data stored at the fourth pages must be backed up. This operation may be performed the same as described in FIGS. 6 and 7, and a redundant description thereof is thus omitted.

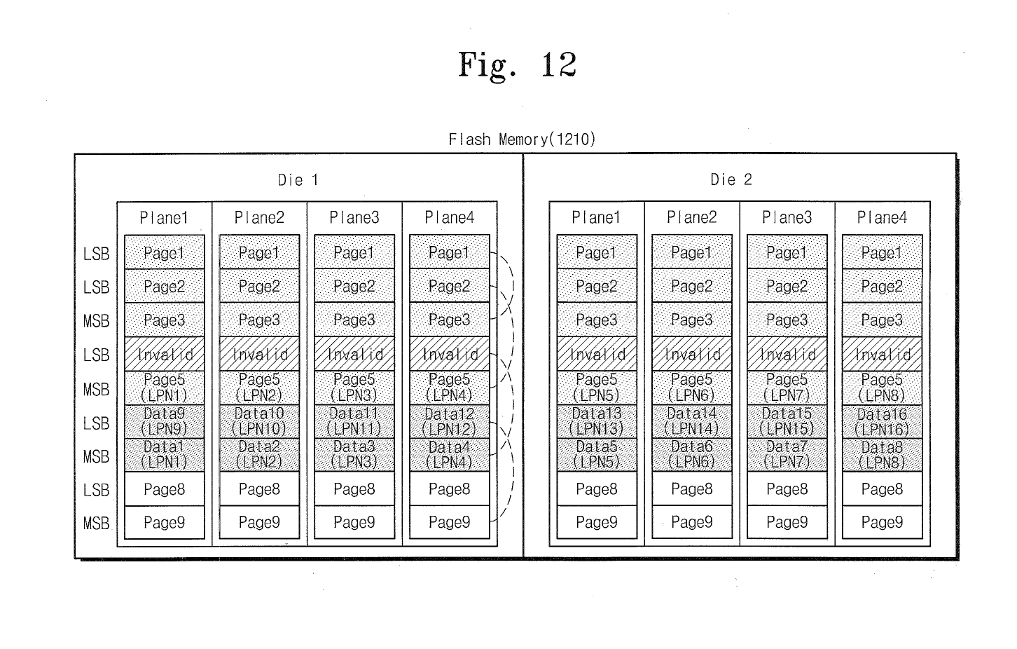

Referring to FIG. 12, there is illustrated an example of a MLC program manner of a flash storage device according to an exemplary embodiment of the inventive concept.

As illustrated in FIG. 12, a flash storage device 1200 according to an exemplary embodiment of the inventive concept may be configured to program 9^{th} to 16^{th} data Data9 to Data16 prior to programming 1^{st} to 8^{th} data Data1 to Data8.

In this case, LSB data stored at fourth pages (page 4) paired with seventh pages (page7) may be invalidated before seventh pages are programmed. Thus, LSB data stored at the fourth pages (page4) need not be backed up. This is similar to that described with reference to FIGS. 8 and 9, and redundant description thereof is thus omitted.

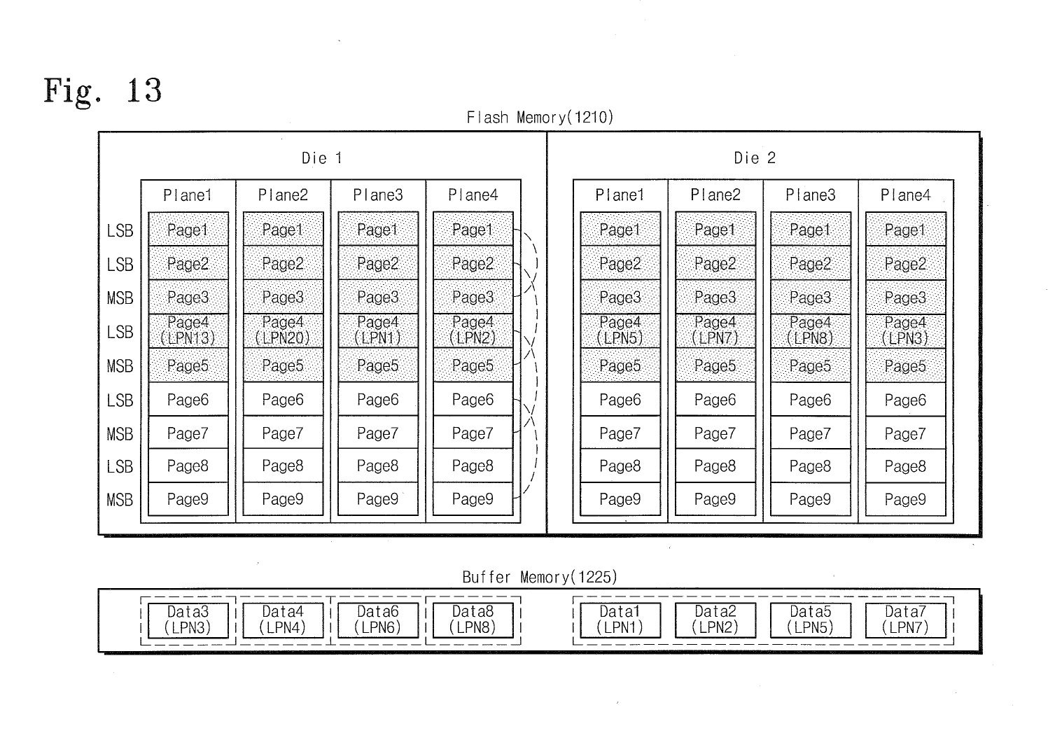

FIGS. 13 to 15 are diagrams illustrating a flash storage device according to an exemplary embodiment of the inventive concept. In FIGS. 13 to 15, a flash storage device sequentially programs paired LSB and MSB pages spanning four planes (Plane1 through Plane4) on each of two dies (Die1 and Die2).

For ease of description, a flash storage device to be described with reference to FIGS. 13 to 15 is similar to the flash storage device described with reference to FIGS. 10 to 12. Except, while the flash storage device in FIGS. 10 to 12 performs a program operation from a first page to a ninth page (Page1 to Page9), the flash storage device in FIGS. 13 to 15 sequentially performs programming of paired LSB and MSB pages.

For example, in FIGS. 13 to 15, it is assumed that an LSB program operation on a first page (Page1) is performed and then a program operation on a third page (Page3) paired with the first page (Page1) is performed. Also, it is assumed that an LSB program operation on the second page (Page2) is performed and then a program operation on a fifth page (Page5) paired with the second page (Page2) is performed.

Also, in FIGS. 13 to 15, it is assumed that data is write-requested from a host 1100 (refer to FIG. 2) in the order of Data3, Data4, Data6, Data8, Data1, Data2, Data5, and Data7.

Referring to FIG. 13, the write-requested data Data3, Data4, Data6, Data8, Data1, Data2, Data5, and Data7 may be stored at a buffer memory 1225.

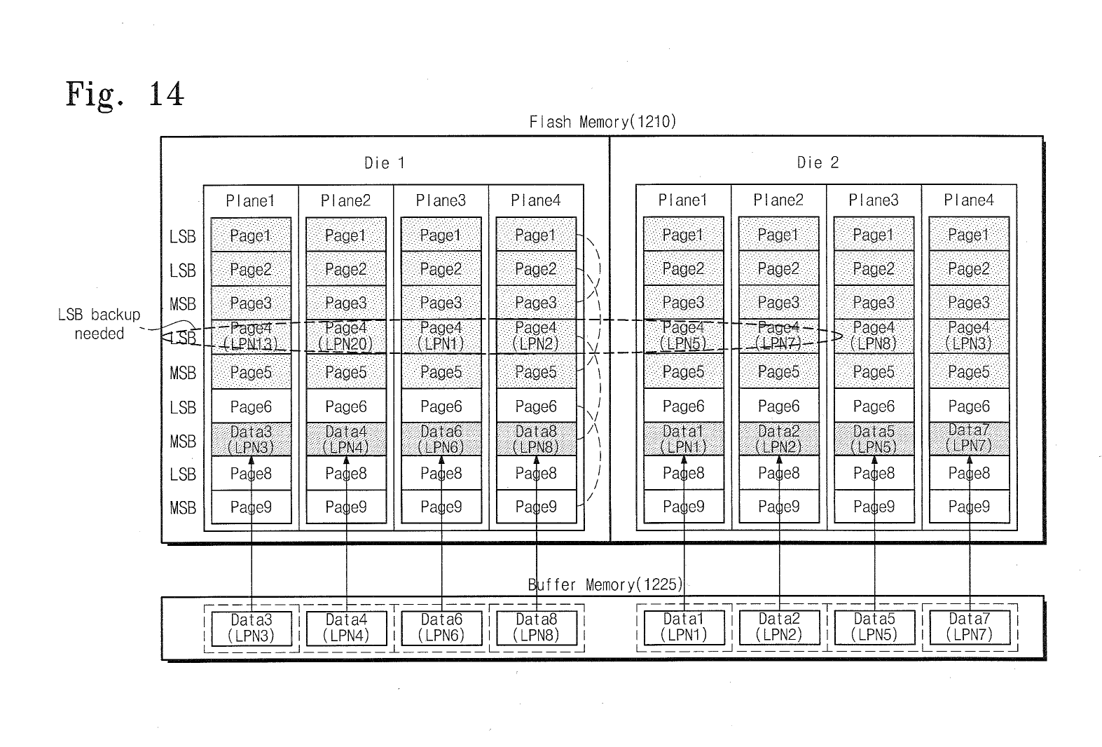

Referring to FIG. 14, there is illustrated an example that the write-requested data Data3, Data4, Data6, Data8, Data1, Data2, Data5, and Data7 are sequentially programmed into the flash memory 1210 according to a sequence write-requested by a host 1100.

As illustrated in FIG. 14, in a case where the write-requested data Data3, Data4, Data6, Data8, Data1, Data2, Data5, and Data7 are sequentially programmed into seventh pages (Page7) of the flash memory 1210, an LSB backup operation must be performed with respect to six fourth pages (Page4) in first and second dies. The reason is that most of LSB data stored at fourth pages (Page4) paired with seventh pages (Page7) is valid data when the seventh pages (Page7) are MSB-programmed.

For example, in the event that an MSB program operation on the seventh page (Page7) of a third plane (Plane3) in the first die (Die1) is performed, LSB data stored at a paired fourth page (Page4) may be still valid data. In this case, LSB data stored at the fourth page (Page4) of the third plane (Plane3) in the first die (Die1) must be backed up. This may be performed the same as described with reference to FIGS. 6 and 7, and redundant description thereof is thus omitted.

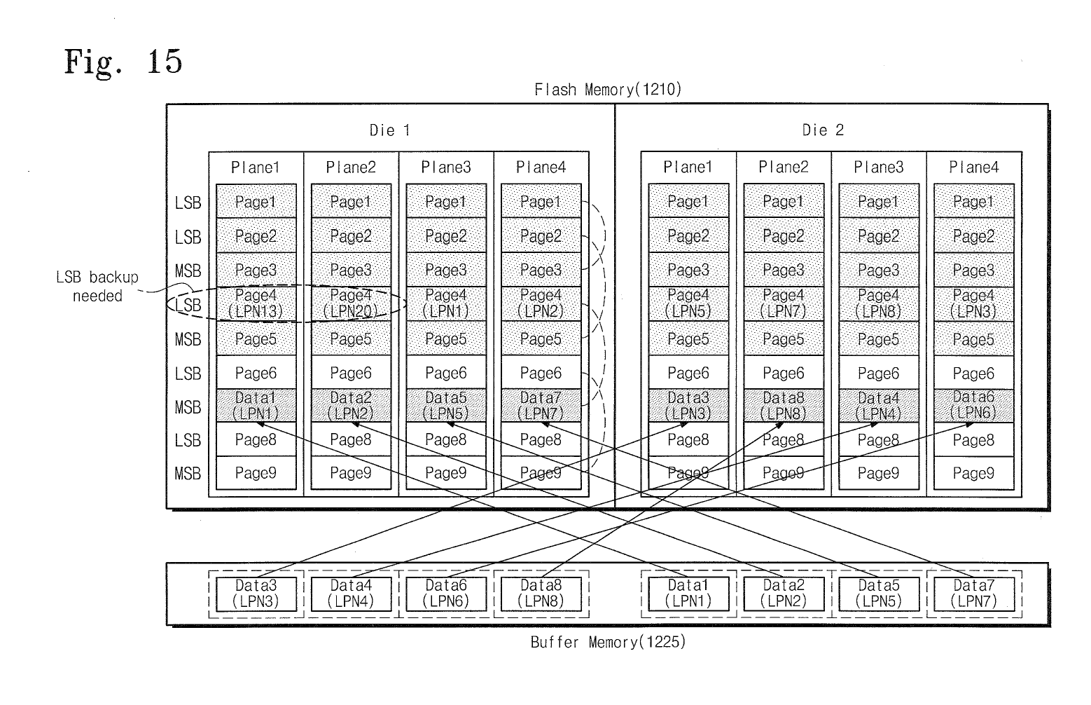

Referring to FIG. 15, there is illustrated an example of a program manner of a flash storage device 1200 according to an exemplary embodiment of the inventive concept. The flash storage device 1200 adjusts the program sequence on write-requested data such that LSB data stored at fourth pages (Page4) paired with seventh pages (Page7) is invalidated prior to programming of the seventh pages (Page7).

For example, as illustrated in FIG. 15, the program sequence on write-requested data may be changed into such an order as Data1, Data2, Data5, Data7, Data3, Data8, Data4, and Data6 in the case that the write-requested data Data3, Data4, Data6, Data8, Data1, Data2, Data5, and Data7 is the sequence write-requested by a host 1100.

Unlike FIG. 14, in this case, an LSB backup operation on (only) two fourth pages (page4) is necessary. The reason for this is that most of the LSB data is invalidated prior to programming of paired MSB data by adjusting the program sequence on the write-requested data.

For example, LSB data of a fourth page (Page4) of a third plane (Plane3) in the first die is invalidated by an MSB program operation of a seventh page (Page7) of a first plane (Plane1) in the first die. In a case where an MSB program operation on a seventh page (Page1) of the third plane (Plane3) in the first die is performed, an LSB backup operation on a paired fourth page (Page4) need not be performed. This may be similar to that described with reference to FIGS. 8 and 9, and redundant description thereof is thus omitted.

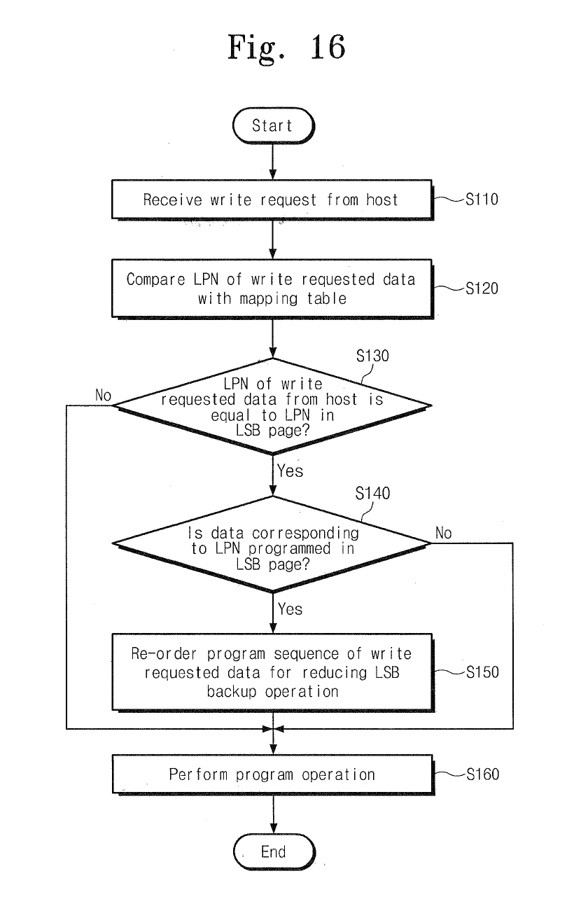

FIG. 16 is a flow chart illustrating the method of a program operation of a flash storage device according to an exemplary embodiment of the inventive concept. Below, the method of a program operation of a flash storage device according to an exemplary embodiment of the inventive concept will be described with reference to FIGS. 2 to 15.

In step S110, a flash storage device 1200 receives a write request from a host 1100. In this case, write-requested data and a logical page number(s) LPN of the write-requested data are provided to the flash storage device 1200 together with the write request.

In step S120, the flash storage device 1200 compares the logical page number(s) of the write-requested data with a logical page number(s) managed at a mapping table 1222. For example, a mapping checker 1223 of the flash storage device 1223 may perform a comparison operation.

In decision step S130, whether the logical page number of the write-requested data coincides with a logical page number managed at a mapping table 1222 is judged.

If the logical page number (LPN) of the write-requested data does not coincide with a logical page number (LPN) managed at the mapping table 1222 (NO branch of decision step S130), in program step S160, the program operation may be performed according to the original sequence write-requested by the host 1100.

If the logical page number of the write-requested data coincides with a logical page number managed at the mapping table 1222 (YES branch of decision step S130), in decision step S140, a mapping checker 1223 checks whether a physical page of a corresponding logical page number is an LSB page.

If a physical page of a corresponding logical page number is an LSB page (YES branch of decision step S130), in step S150, a backup manager 1224 adjusts the program sequence of write-requested data such that an LSB backup operation is minimized. For example, as described with reference to FIGS. 2 to 9, the backup manager 1224 may invalidate data stored at an LSB page before a program operation on an MSB page paired with the LSB page is performed. Thus, it is possible to minimize an LSB backup operation.

Also, as described with reference to FIGS. 10 to 15, a program sequence adjusting method according to an exemplary embodiment of the inventive concept may be applied to not only a program unit formed of a plurality of pages but also the case that paired LSB and MSB pages are sequentially programmed.

If a physical page of a corresponding logical page number is an MSB page (NO branch of decision step S130), (even if the logical page number of the write-requested data coincides with a logical page number managed at the mapping table 1222 (YES branch of decision step S130)), in step S160, the program operation may be performed according to the original sequence write-requested by the host 1100.

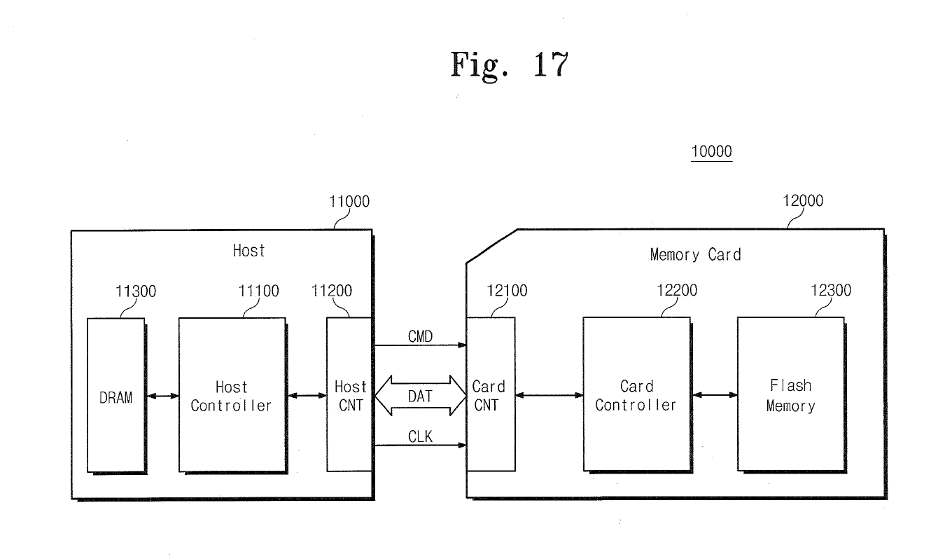

FIG. 17 is a block diagram of a memory card system incorporating a flash memory system according to an exemplary embodiment of the inventive concept. A memory card system 10000 includes a host 11000 and a memory card 12000. The host 11000 may include a host controller 11100, a host connection unit 11200, and a DRAM 11300.

The host 11000 can write data into the memory card 12000 and read data from the memory card 12000. The host controller 1110 can send a command (e.g., a write command), a clock signal CLK generated from a clock generator (not shown) in the host 11000, and data to the memory card 12000 via the host connection unit 11200. The DRAM 11300 can be a main (system) memory of the host 11000.

The memory card 12000 includes a card connection unit 12100, a card controller 12200, and a flash memory 12300. The card controller 12200 can store data in the flash memory 12300 in response to a command input via the card connection unit 12100. The data can be stored in synchronization with a clock signal generated from a clock generator (not shown) in the card controller 12200. The flash memory 12300 can store data transferred from the host 1100. For example, in a case where the host 11000 is a digital camera, the flash memory 12300 may store image data.

The memory card system 10000 can program write-requested data before programming of an MSB page paired with an LSB page at which old data of the write-requested data is stored. Thus, it is possible to minimize an LSB backup operation.

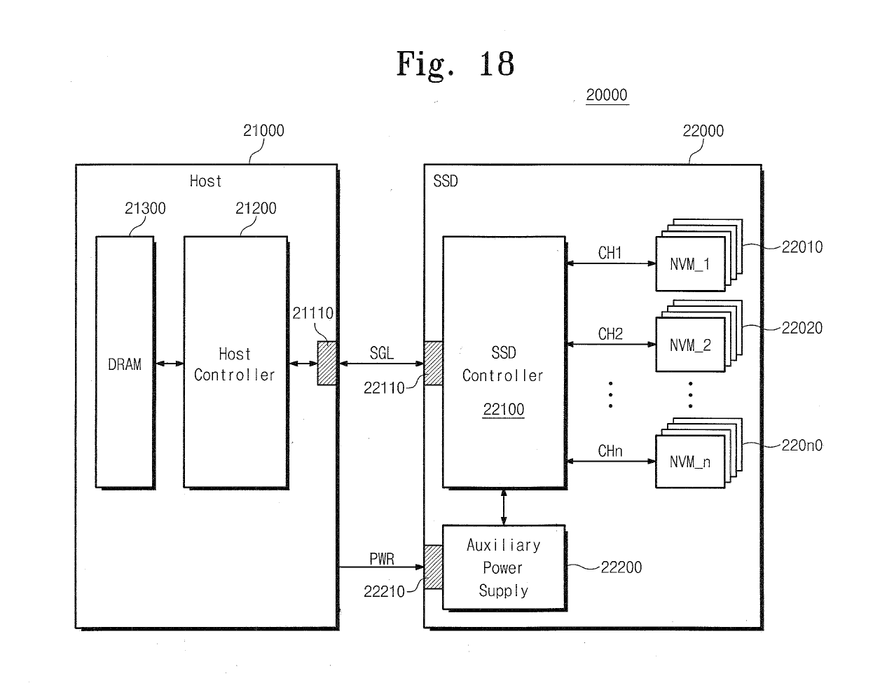

FIG. 18 is a block diagram illustrating a solid state drive system incorporating a memory system according to the inventive concept is applied. Referring to FIG. 18, a solid state drive (SSD) system 20000 includes a host 21000 and an SSD 22000. The host 21000 includes a host interface 21110, a host controller 21200, and a DRAM 21300.

The host 21000 can write data in the SSD 22000 or read data from the SSD 22000. The host controller 21200 can transfer signals SGL such as a command, an address, a control signal, and the like to the SSD 22000 via the host interface 21110. The DRAM 21300 can be a main (system) memory of the host 21000.

The SSD 22000 can exchange signals SGL with the host 21000 via the host interface 22110, and can be supplied with a power via a power connector 22210. The SSD 22000 can include a plurality of nonvolatile memories 22010 through 220n0, an SSD controller 22100, and an auxiliary power supply 22200. Herein, the nonvolatile memories 22010 to 220n0 may be implemented by not only a NAND flash memory but also nonvolatile memories such as PRAM, MRAM, ReRAM, and the like.

The plurality of nonvolatile memories 22010 through 220n0 can be used as a storage medium of the SSD 22000. The plurality of nonvolatile memories 22010 to 220n0 can be connected with the SSD controller 22100 via a plurality of channels CH1 to CHn. One channel can be connected with one or more nonvolatile memories. Nonvolatile memories connected with one channel can be connected with the same data bus.

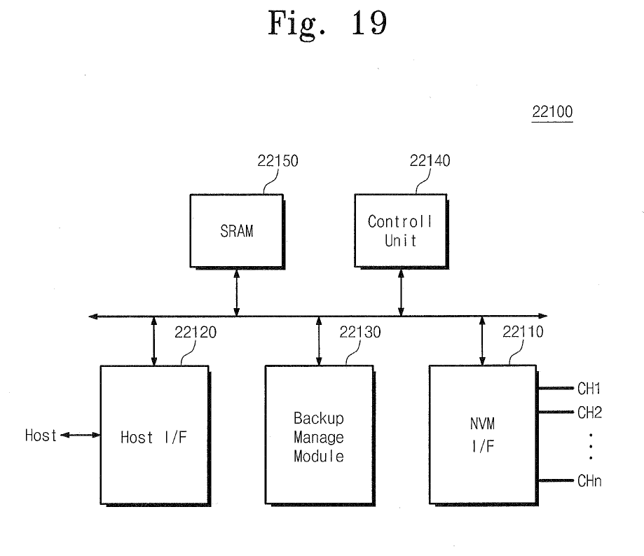

The SSD controller 22100 can exchange signals SGL with the host 21000 via the host interface 22110. Herein, the signals SGL include a command, an address, data, and the like. The SSD controller 22100 can be configured to write or read out data to or from a corresponding nonvolatile memory according to a command of the host 21000. The SSD controller 22100 will be more fully described with reference to FIG. 19.

The auxiliary power supply 22200 can be connected with the host 21000 via the power connector 22210. The auxiliary power supply 22200 may be charged by a power PWR from the host 21000. The auxiliary power supply 22200 may be placed inside or outside the SSD 22000. For example, the auxiliary power supply 22200 may be put on a main board to supply the auxiliary power to the SSD 22000.

FIG. 19 is a block diagram of an SSD controller in the solid state drive system of FIG. 18. Referring to FIG. 19, an SSD controller 22100 includes an NVM interface 22110, a host interface 22120, a backup manage module 22130, a control unit 22140, and an SRAM 22150.

The NVM interface 22110 can distribute data transferred from a main memory of a host 21000 to channels CH1 to CHn, respectively. The NVM interface 22110 can transfer data read from nonvolatile memories 22010 to 220n0 to the host 21000 via the host interface 22120.

The host interface 22120 provides an interface with an SSD 22000 according to the protocol of the host 21000. The host interface 2212 may communicate with the host 21000 using protocols such as USB (Universal Serial Bus), SCSI (Small Computer System Interface), PCI express, ATA, PATA (Parallel ATA), SATA (Serial ATA), SAS (Serial Attached SCSI), etc. The host interface 22120 may perform a disk emulation function which enables the host 21000 to recognize the SSD 22000 as a hard disk drive (HDD).

The backup manage module 22130, as described with reference to FIG. 1, judges whether a logical address of write-requested data coincides with a logical address corresponding to predetermined data of data stored at a nonvolatile memory. If a logical address of write-requested data coincides with a logical address corresponding to predetermined data of data stored at a nonvolatile memory, the backup manage module 22130 adjusts the program sequence of write-requested data (or, the program location of write-requested data) to minimize an LSB backup operation.

The SRAM 22150 can be used to drive software which efficiently manages the nonvolatile memories 22010 to 220n0. The SRAM 22150 can store metadata input from a main memory of the host 21000 or cache data. At a sudden power-off operation, metadata or cache data stored in the SRAM 22150 may be stored in the nonvolatile memories 22010 to 220n0 using an auxiliary power supply 22200.

The SSD system 20000 can program write-requested data before programming of an MSB page paired with an LSB page at which old data of the write-requested data is stored. Thus, it is possible to minimize an LSB backup operation.

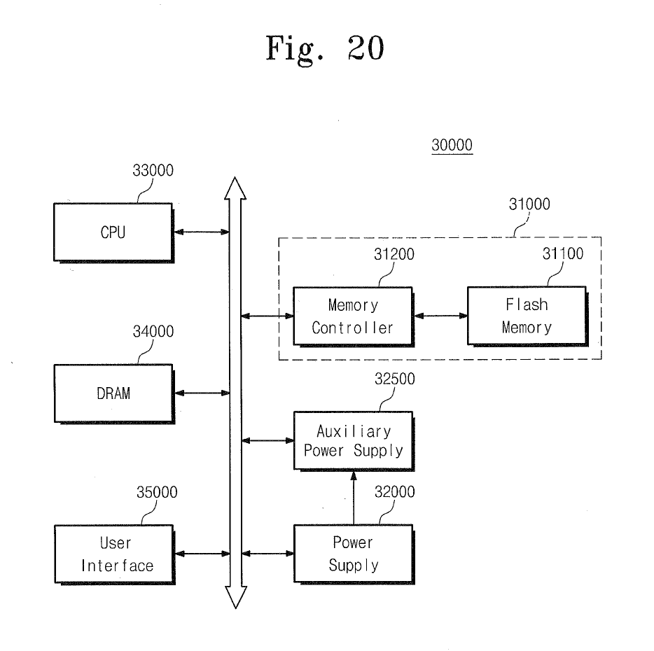

FIG. 20 is a block diagram of an electronic device including a flash memory system according to an exemplary embodiment of the inventive concept. Herein, the electronic device 30000 may be a personal computer or a handheld electronic device such as a notebook computer, a cellular phone, a PDA, a camera, and the like.

Referring to FIG. 20, the electronic device 30000 may include a memory system 31000, a power supply device 32000, an auxiliary power supply 32500, a CPU 3300, a DRAM 34000, and a user interface 35000. The memory system 31000 includes a flash memory 31100 and a memory controller 31200. The memory system 31000 can be embedded within the electronic device 30000.

The electronic device 30000 can program write-requested data before programming of an MSB page paired with an LSB page at which old data of the write-requested data is stored. Thus, it is possible to minimize an LSB backup operation.

A memory system according to an exemplary embodiment of the inventive concept is applicable to a flash memory having a three-dimensional structure (e.g., multiple planes) as well as a flash memory having a two-dimensional structure (e.g., one plane).

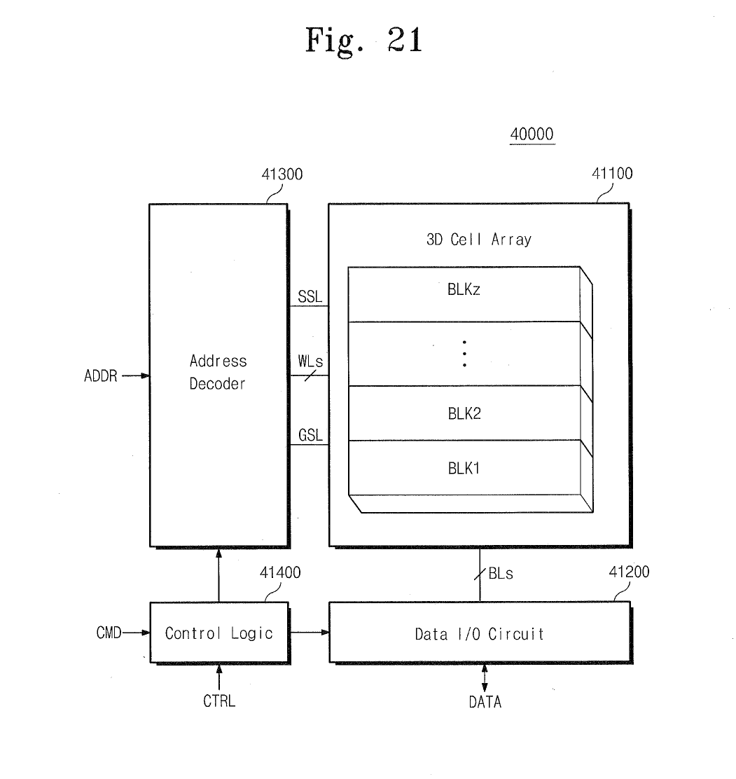

FIG. 21 is a block diagram of a flash memory according to an exemplary embodiment of the inventive concept. Referring to FIG. 21, the flash memory 40000 includes a three-dimensional (3D) cell array 41100, a data input/output circuit 41200, an address decoder 41300, and control logic 41400.

The 3D cell array 41100 includes a plurality of memory blocks BLK1 to BLKz, each of which is formed to have a three-dimensional structure (or, a vertical structure). For a memory block having a two-dimensional (horizontal) structure, memory cells may be formed in a direction horizontal to a substrate. For a memory block having a three-dimensional structure (e.g., 3D cell array 41100), memory cells may be formed in a direction perpendicular to the substrate. Each memory block can be a block-erase unit of the flash memory 40000.

The data input/output circuit 41200 to be connected with the 3D cell array 41100 via a plurality of bit lines BLs. The data input/output circuit 41200 can receives data from an external device or output data read from the 3D cell array 41100 to the external device. The address decoder 41300 is connected with the 3D cell array 41100 via a plurality of word lines Wls and selection lines GSL and SSL. The address decoder 41300 selects the currently active word lines in response to an address ADDR.

The control logic 41400 controls programming, erasing, reading, etc. of the flash memory 40000. For example, at programming, the control logic 41400 can control the address decoder 41300 such that a program voltage is supplied to a currently selected word line, and can control the data input/output circuit 41200 such that data is programmed.

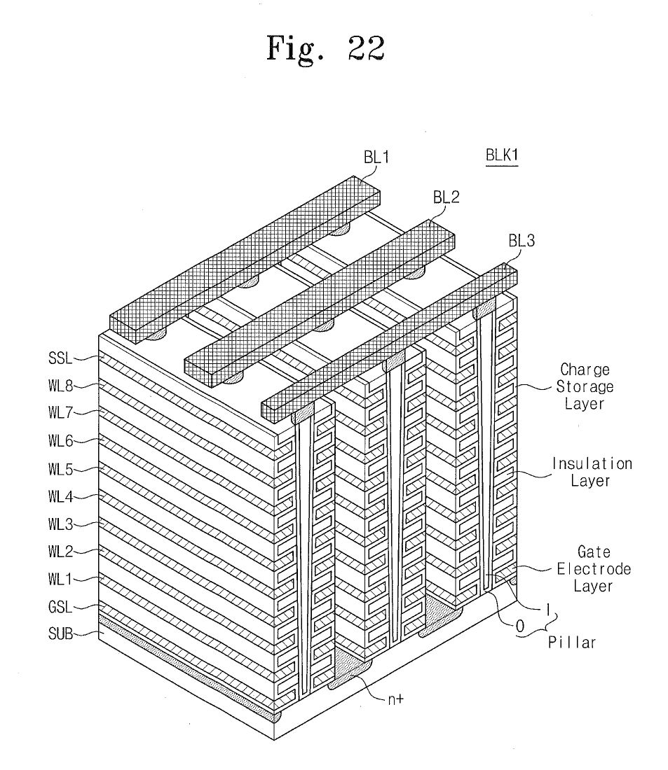

FIG. 22 is a perspective view schematically illustrating the three-dimensional (3D) structure of a memory block illustrated in FIG. 21. Referring to FIG. 22, the memory block BLK1 is formed in a direction perpendicular to a substrate SUB. An n+ doping region is formed at the substrate SUB. The gate electrode layers and an insulation layers may be alternately deposited on the substrate SUB.

If the gate electrode layer and the insulation layer are patterned in a vertical direction, a V-shaped pillar may be formed. The pillar is connected with the substrate SUB and is adjacent to the gate electrode layer and the insulation layer. An outer portion O of the pillar may be formed of a channel semiconductor, and an inner portion I thereof may be formed of an insulation material such as silicon oxide. A charge storage layer having a vertical aspect is formed between the gate electrode layer and the outer portion O of the pillar. A vertical aspect of the charge storage layer may be formed between the gate electrode layer and the outer portion O of the pillar.

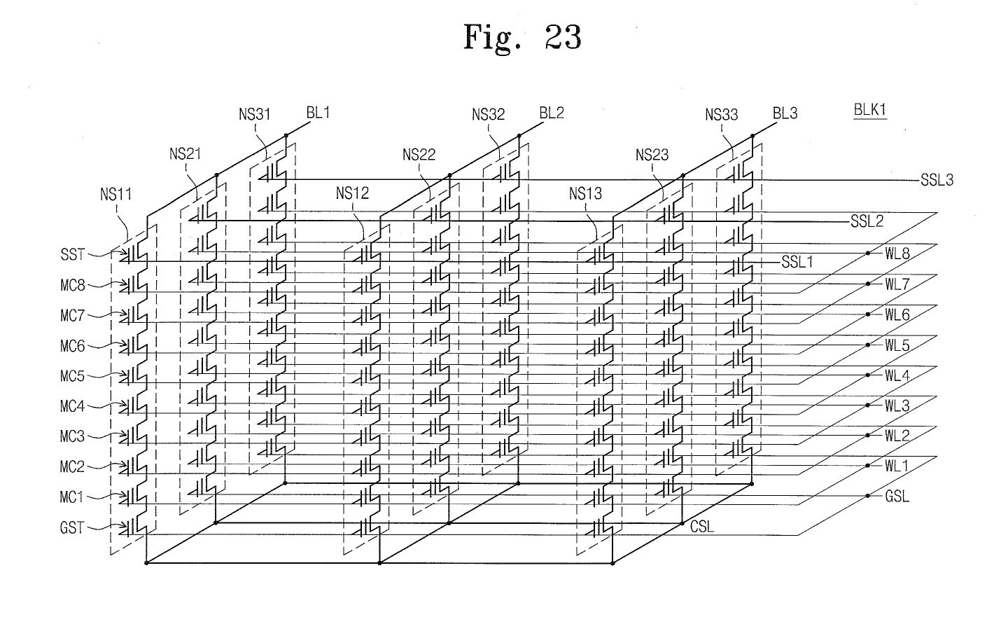

The gate electrode layers of the memory block BLK1 may comprise a ground selection line GSL, a plurality of word lines WL1 to WL8, and a string selection line SSL. The pillars of the memory block BLK1 are connected with a plurality of bit lines BL1 to BL3. In FIG. 23, there is illustrated the case that one memory block BLK1 has two selection lines SSL and GSL, eight word lines WL1 to WL8, and three bit lines BL1 to BL3. However, the inventive concept is not limited thereto.

FIG. 23 is a circuit diagram of an equivalent circuit of the memory block illustrated in FIG. 22. Referring to FIG. 23, NAND strings NS11 to NS33 are connected between bit lines BL1 to BL3 and a common source line CSL. Each NAND string (e.g., NS11) includes a string selection transistor SST, a plurality of memory cells MC1 to MC8, and a ground selection transistor GST.

The string selection transistors SST may be connected with string selection lines SSL1 to SSL3. The memory cells MC1 to MC8 may be connected with corresponding word lines WL1 to WL8, respectively. The ground selection transistors GST may be connected with ground selection line GSL. A string selection transistor SST may be connected with a bit line and a ground selection transistor GST may be connected with a common source line CSL.

Word lines (e.g., WL1) having the same height may be connected in common, and the string selection lines SSL1 to SSL3 may be separated from one another. At programming of memory cells (constituting a page) connected with a first word line WL1 and included in NAND strings NS11, NS12, and NS13, there may be selected a first word line WL1 and a first string selection line SSL1.

While the inventive concept has been described with reference to exemplary embodiments, it will be apparent to those skilled in the art that various changes and modifications may be made without departing from the spirit and scope of the present invention. Therefore, it should be understood that the above embodiments are not limiting, but illustrative.

What is claimed is:

1. A nonvolatile memory device comprising:
a nonvolatile memory; and
a controller configured to control the nonvolatile memory,
wherein if the logical address of write-requested data coincides with the logical address of data already stored in the nonvolatile memory, the controller controls the nonvolatile memory to program the write-requested data prior to programming of a page sharing the same word line as the page including the data already stored at the nonvolatile memory.

2. The nonvolatile memory device of claim 1, wherein if the logical address of the write-requested data coincides with the logical address of the data already stored in the nonvolatile memory and the page including the data already stored in the nonvolatile memory is an LSB page, the controller invalidates the data already stored at the nonvolatile memory prior to programming of an MSB page sharing the same word line as the LSB page including the data already stored in the nonvolatile memory.

3. The nonvolatile memory device of claim 1, wherein the controller comprises:
a mapping checker configured to compare the logical address of the write-requested data with the logical address of the data already stored in the nonvolatile memory; and
a backup manager configured to determine a location, at which the write-requested data is to be programmed at the nonvolatile memory, based on the comparison result.

4. The nonvolatile memory device of claim 3, wherein the controller further comprises a mapping table configured to manage a logical address of the data stored in the nonvolatile memory, a physical address of the data stored in the nonvolatile memory, and information indicating whether a page including the data already stored in the nonvolatile memory is an LSB page.

5. The nonvolatile memory device of claim 4, wherein the mapping checker compares the logical address of the write-requested data with a logical address managed at the mapping table; and wherein if the logical address of the write-requested data coincides with the logical address managed at the mapping table, the mapping checker judges whether a page including data, corresponding to the logical address, from among data stored in the nonvolatile memory is an LSB page.

6. The nonvolatile memory device of claim 5, wherein if the logical address of the write-requested data coincides with the logical address managed at the mapping table and the page including data, corresponding to the logical address, already stored in the nonvolatile memory is an LSB page, then the backup manager performs a program operation on the write-requested data prior to performing an MSB program operation on an MSB page sharing the same word line as the LSB page.

7. The nonvolatile memory device of claim 5, wherein if the logical address of the write-requested data coincides with the logical address managed at the mapping table and the page including data, corresponding to the logical address, from among data stored in the nonvolatile memory is an MSB page, then the backup manager performs a program operation on the write-requested data according to a sequence write-requested by a host.

8. The nonvolatile memory device of claim 5, wherein if the logical address of the write-requested data does not coincide with the logical address managed at the mapping table, then the backup manager performs a program operation on the write-requested data according to a sequence write-requested by a host.

9. The nonvolatile memory device of claim 1, wherein the controller controls the nonvolatile memory to perform a program operation by a unit of plural pages.

10. The nonvolatile memory device of claim 1, wherein the nonvolatile memory comprises:
a first word line;
a second word line adjacent to the first word line; and
a third word line adjacent to the second word line,
wherein the first wordline is the word line of the page including the data already stored at the nonvolatile memory;
the controller controlling the nonvolatile memory to perform an LSB program operation on the third word line after performing an MSB program operation on the first word line.

11. The nonvolatile memory device of claim 10, wherein the nonvolatile memory further comprises a fourth word line adjacent to the third word line, and
wherein if the logical address of the write-requested data coincides with the logical address of data stored at an LSB page of the third word line, the controller controls the nonvolatile memory to perform a program operation on the MSB page of the third word line after the write-requested data is programmed at an LSB page of the fourth word line.

12. The nonvolatile memory device of claim 1, wherein the nonvolatile memory comprises a first word line; and a second word line adjacent to the first word line, and
wherein the controller controls the nonvolatile memory such that an LSB program operation on the first word line, an MSB program operation on the first word line, an LSB program operation on the second word line, and an MSB program operation on the second word line are sequentially performed.

13. A program method of a nonvolatile memory device supporting multi-level cell data storage, the program method comprising:
receiving write-requested data sequentially;
comparing the logical address of the write-requested data with a logical address managed at a mapping table; and
if the logical address of the write-requested data coincides with the logical address managed at the mapping table, then programming the write-requested data prior to programming of a page sharing the same word lines as a physical page to which the logical address belongs.

14. The program method of claim 13, further comprising:
if the logical address of the write-requested data coincides with the logical address managed at the mapping table, then checking whether a physical page corresponding to the logical address managed at the mapping table is an LSB page.

15. The program method of claim 14, further comprising:
performing a program operation according to a sequence write-requested by a host when the logical address of the write-requested data does not coincide with the logical address managed at the mapping table.

16. A nonvolatile memory device comprising:
a nonvolatile memory supporting multi-level cell data storage and including:
a first word line;
a second word line adjacent to the first word line; and
a third word line adjacent to the second word line; and
a controller including:
a mapping checker configured to compare the logical address of write-requested data with the logical address of data already stored in the nonvolatile memory; and
a backup manager configured to determine which wordline among the first, second, and third wordlines, at which the write-requested data is to be programmed in the nonvolatile memory, based on the comparison result.

17. The nonvolatile memory device of claim 16, wherein the controller is configured to perform a program operation on the write-requested data according to a sequence write-requested by a host if a first condition or a second condition is detected.

18. The nonvolatile memory device of claim 17, further comprising:
a mapping table configured to manage a logical address of the data stored in the nonvolatile memory, a physical address of the data stored in the nonvolatile memory, and information indicating whether a page including the data already stored in the nonvolatile memory is an LSB page,
wherein the first condition is that the logical address of the write-requested data coincides with a logical address managed at the mapping table and the page including data, corresponding to the logical address, from among data already stored in the nonvolatile memory is an MSB page, and
wherein the second condition is that the logical address of the write-requested data does not coincide with a logical address managed at the mapping table.

19. The nonvolatile memory device of claim 18, wherein the controller is configured to perform a program operation on the write-requested data according to a sequence different from a sequence write-requested by a host if a third condition is detected.

20. The nonvolatile memory device of claim 19, wherein the third condition is that the logical address of write-requested data coincides with the logical address of data already stored in the nonvolatile memory, and the page corresponding to the logical address of data already stored in the nonvolatile memory is an LSB page.
